(19) United States
(12) Patent Application Publication
(10) Pub. No.: US 2007/0230735 A1
(43) Pub. Date: Oct. 4, 2007

(54) Selective type headset

(75) Inventors: Kyung-Eun Sung, Seoul (KR); Sang-Min Hyun, Seoul (KR); Chang-Soo Lee, Bupyeong-gu (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/717,499

(22) Filed: Mar. 13, 2007

(30) Foreign Application Priority Data
Mar. 16, 2006 (KR) 2006-24264

(51) Int. Cl. H04R 25/00

(52) U.S. Cl. 381/374; 381/377

(57) ABSTRACT

A selective type headset for a mobile communication terminal includes a first earphone part having a face provided with a first attachment receptacle and a first attachment protrusion adjacent to the first attachment receptacle, and a second earphone part having a face provided with a second attachment receptacle and a second attachment protrusion adjacent to the second attachment receptacle, whereby the first earphone part is attachable to the second earphone part in a face to face manner by engaging the first and second attachment protrusions respectively with the second and first attachment receptacles. The attachment protrusions and receptacles enable the user to conveniently carry the headset by attaching the earphone parts in a face to face manner. The headset selectively provides mono or stereo sound.

### PRIORITY

This application claims priority under 35 U.S.C. §119 to an application entitled “Bluetooth Earphone Set with Novel Attachment for Mono-Stereo Common Use” filed in the Korean Intellectual Property Office on Mar. 16, 2006 and assigned Serial No. 2006-0024264, the contents of which are incorporated herein by reference.

### BACKGROUND OF THE INVENTION

1. Field of the Invention

The present invention relates to a headset held at a user's head for converting electrical sound signals coming from a sound instrument into sound waves delivered to the user's ear, and for converting the user's voice into electrical sound signals delivered to the sound instrument to record or to a mobile communication terminal to perform mobile communication.

2. Description of the Related Art

Headsets have been favorably employed, for example, by telemarketers or public relations individuals to perform telemarketing or advertisement through telecommunication or Internet communications. Typical headsets include a speaker part for producing sound waves and a microphone part for converting the user's voice into electrical signals.

Mobile communication services are expanding into multimedia operability through communication technology and equipment development, and accordingly the mobile communication terminal has been developed to exceed the basic communication function and to have such multimedia functions as to reproduce music or video data files with the help of dramatically improved data compression technology.

Such a versatile mobile communication terminal enables the user to enjoy multimedia functions in addition to the basic communication function more effectively by using the headset. To this end various types of headsets have been proposed. For example, one type of headset includes earphone parts each with a hook for holding the helix, and cables held at the nape of the neck connecting the earphone parts. Another type of headset includes earphone parts each having only a speaker and being directly inserted in the concha of the ear. Still another type of headset includes a single earphone part with a hook or resilient means for holding the helix.

However, such conventional headsets are inconvenient to carry because the two speakerphone parts and their cables cannot be easily and compactly secured when the headset is not being used. Additionally, conventional headsets have usually been provided with only a mono or a stereo sound function, making it impossible to enjoy both voice communication and multimedia functions by using a single headset.

### SUMMARY OF THE INVENTION

It is an object of the present invention to provide a selective type stereo headset with two earphone parts that are compactly attached together in a face to face manner to facilitate convenient transportability. As used herein, the term “selective” means selection between mono and stereo sound function.

It is another object of the present invention to provide a selective type stereo headset with cables connecting the earphone parts are attached with a fixing device to facilitate handling of the cables.

It is still another object of the present invention to provide a headset that enables a user to perform radio communication with a mobile communication terminal in mono sound by using one earphone part, or to make an operational combination of two earphone parts to provide a stereo sound function by employing cables or a Bluetooth module.

According to the present invention, a headset for a mobile communication terminal includes a first earphone part having a face provided with a first attachment receptacle and a first attachment protrusion adjacent to the first attachment receptacle, and a second earphone part having a face provided with a second attachment receptacle and a second attachment protrusion adjacent to the second attachment receptacle, whereby the first earphone part can be attached to the second earphone part in a face to face manner by engaging the first and second attachment protrusions respectively with the second and first attachment receptacles.

### BRIEF DESCRIPTION OF THE DRAWINGS

The above and other objects, features and advantages of the present invention will become more apparent from the following detailed description when taken in conjunction with the accompanying drawing in which:

FIG. 1 is a perspective view of a first selective type headset according to a first embodiment of the present invention;

FIG. 2 is a front view of the first earphone part of a headset as shown in FIG. 1;

FIG. 3 is a right side view of the first earphone part of a headset as shown in FIG. 1;

FIG. 4 is a left side view of the first earphone part of a headset as shown in FIG. 1;

FIG. 5 is a front view of the second earphone part of a headset as shown in FIG. 1;

FIG. 6 is a right side view of the second earphone part of a headset as shown in FIG. 1;

FIG. 7 is a left side view of the second earphone part of a headset as shown in FIG. 1;

FIG. 8 is a perspective view of a headset as shown in FIG. 1 with a fixing device shown in an enlarged scale;

FIG. 9 is a perspective view of a headset as shown in FIG. 1 with the first and second earphone parts attached to each other;

FIG. 10 is a cross-sectioned view of a headset with the earphone parts attached to each other as shown in FIG. 9;

FIG. 11 is a block diagram for illustrating the operation of a headset as shown in FIG. 1;

FIG. 12 is a block diagram for illustrating the operation of a second selective type headset according to a second embodiment of the present invention; and

FIG. 13 is a block diagram for illustrating the operation of a third selective type headset according to a third embodiment of the present invention.

### DETAILED DESCRIPTION OF THE PREFERRED EMBODIMENTS

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

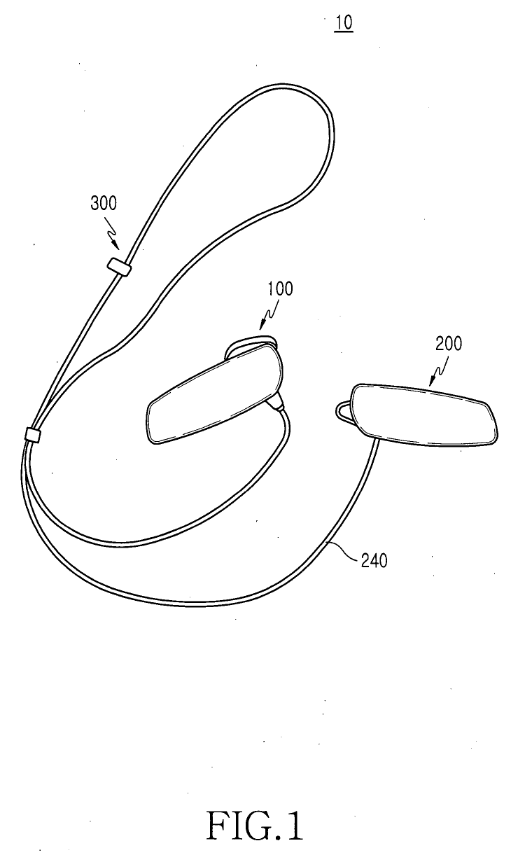

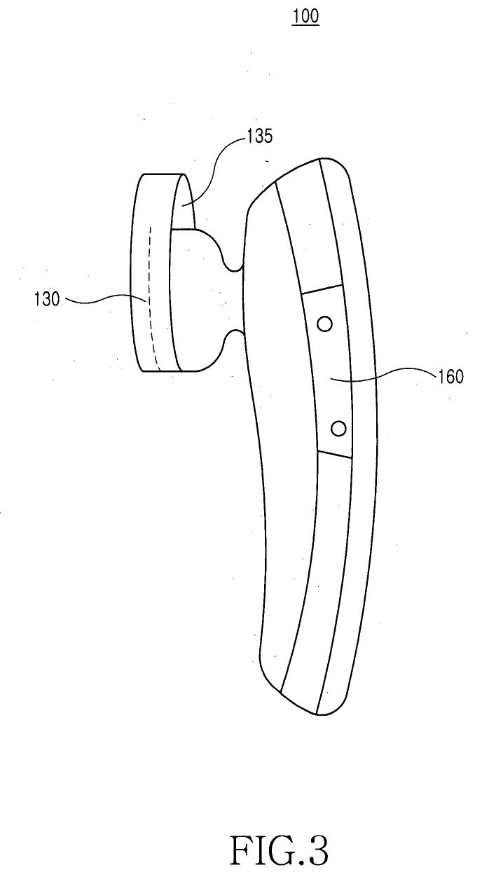

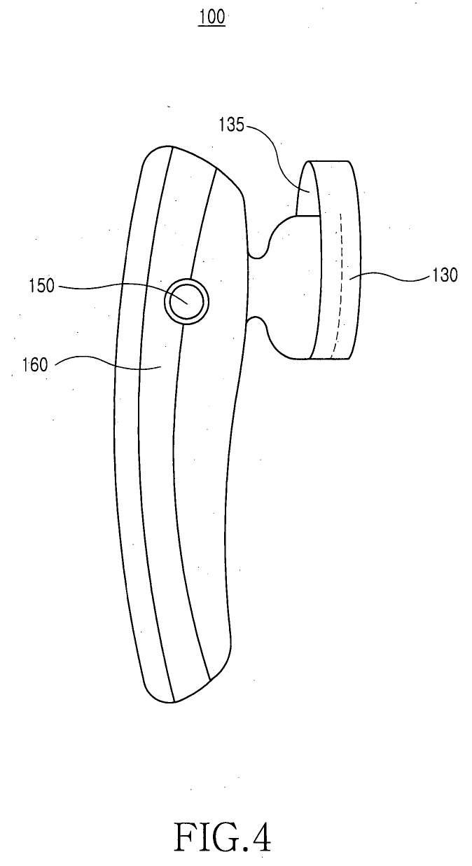

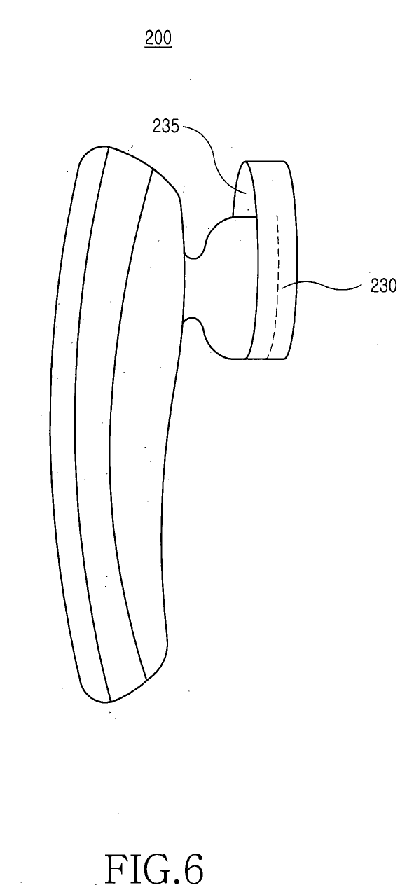

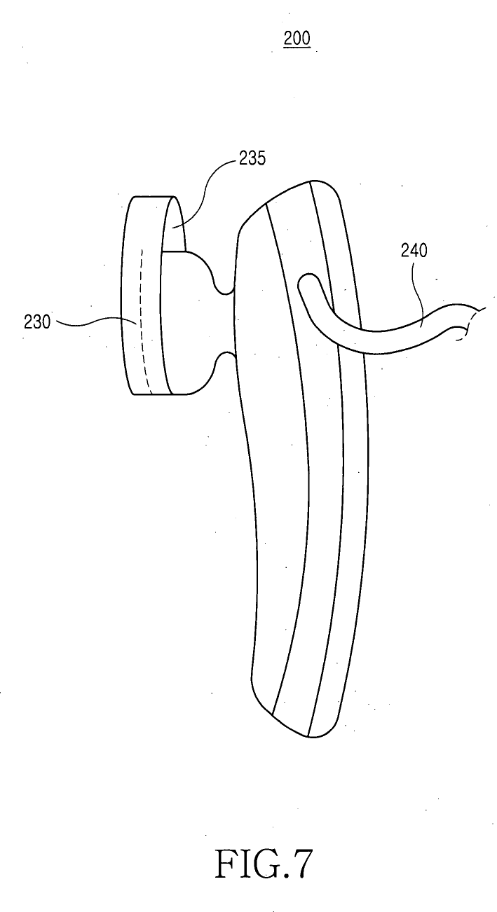

Referring to FIGS. 1 to 7, a first example of a selective type headset 10 according to the present invention includes a first earphone part 100 and a second earphone part 200. The first and second earphone parts 100 and 200 are attached to each other in a face to face manner with attachment receptacles 110 and 210 receiving attachment protrusions 130 and 230, connected through a cable 240.

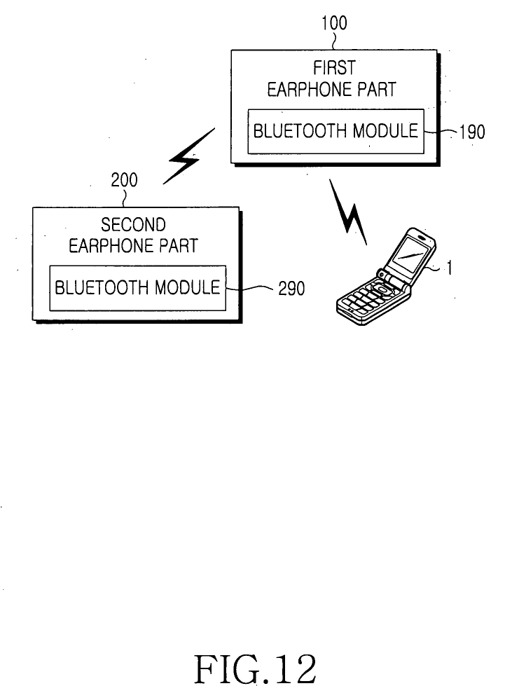

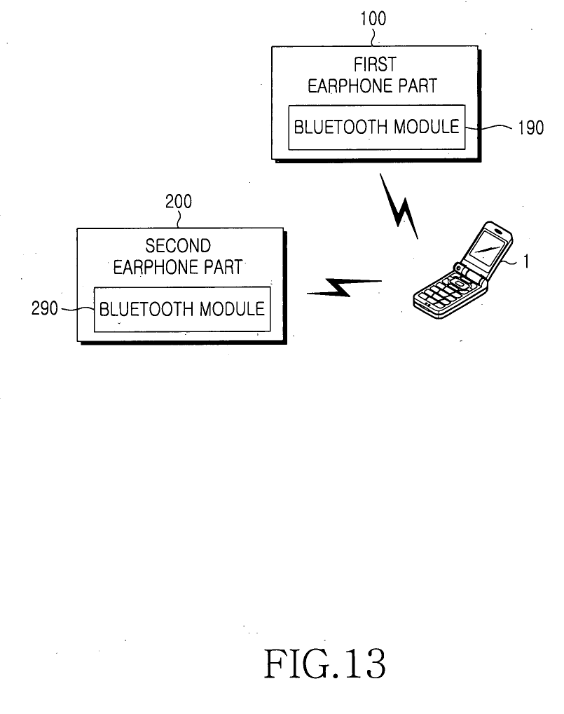

FIGS. 12 and 13 illustrate the operation of second and third examples of selective type headsets according to the present invention. The second and third headset examples have a structure similar to the first headset example except that the first and second earphone parts 100 and 200 are provided respectively with a first and a second Bluetooth module 190 and 290 for performing radio communication.

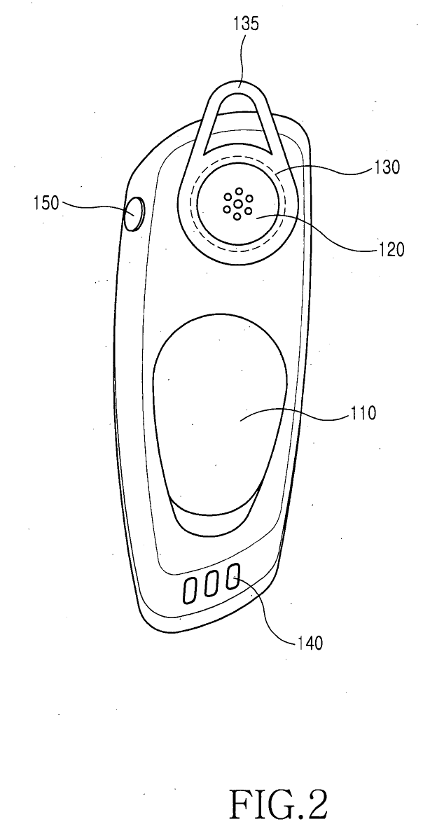

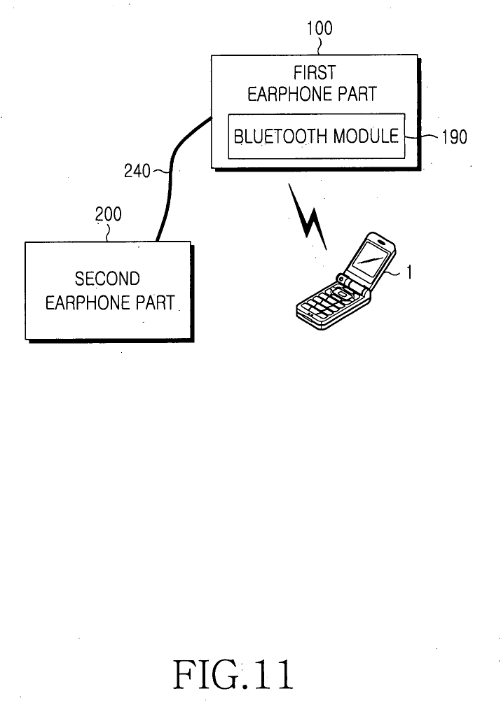

Referring to FIGS. 2 to 4, the first earphone part 100 has a face provided with a first attachment receptacle 110 and a first attachment protrusion 130 adjacent to the first attachment receptacle 110. The first attachment protrusion 130 has a first speaker unit 120 mounted therein, where the first attachment protrusion 130 is provided with a plurality of holes at one side. The first attachment protrusion 130 has a periphery enclosed by a first supporting shell 135, so that the first speaker unit 120 is partly exposed along with the holes formed in the first attachment protrusion 130. The first speaker unit 120 converts a part of an electrical sound signal received from a mobile communication terminal 1, shown in FIGS. 11 to 13, into a sound wave. The first earphone part 100 has a built-in storage battery for supplying power to the selective type headset 10 along with a charging terminal 140 provided at its lower end. The charging terminal 140 is arranged adjacent to the first attachment receptacle 110, connected with an external power supply for recharging the storage battery. The first earphone part 100 also has a side provided with a volume adjustment 160 for adjusting the intensity of the sound wave outputted from the speaker unit 120, and the other side provided with a cable connection terminal 150.

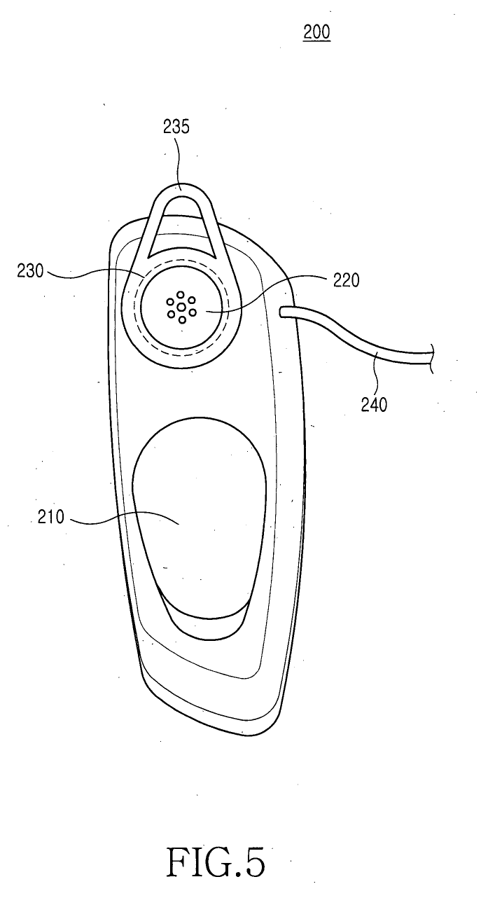

Referring to FIGS. 5 to 7, the second earphone part 200 has a face provided with a second attachment receptacle 210 and a second attachment protrusion 230 adjacent to the second attachment receptacle 210. The second attachment protrusion 230 has a second speaker unit 220 mounted therein, where the second attachment protrusion 230 is provided with a plurality of holes at one side. The second attachment protrusion 230 has a periphery enclosed by a second supporting shell 235, so that the second speaker unit 220 is partly exposed along with the holes formed in the second attachment protrusion 230. The second earphone part 200 also has a side electrically connected to one end of a cable 240 with the other end connected to the cable connection terminal 150 of the first earphone part 100. Thus, the cable 240 connecting the first and second earphone parts 100 and 200 can be held at the nape of the neck of a user of the headset 10. The second speaker unit 220 converts the remaining part of the electrical sound signal received from the first earphone part 100 through the cable 240 into a sound wave.

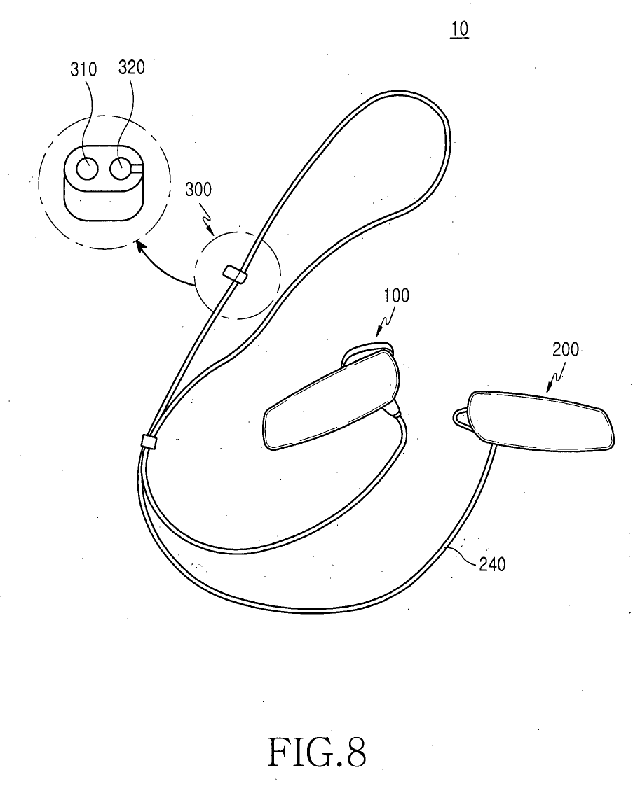

As shown in FIG. 8, the fixing device 300 has a side-closed hole 310 and a side-opened hole 320 with a side slit. The side-closed hole 310 receives the cable 240 and allows the fixing device 300 to move freely along the cable 240. The side-opened hole 320 receives a part of the cable 240 to secure the fixing device 300.

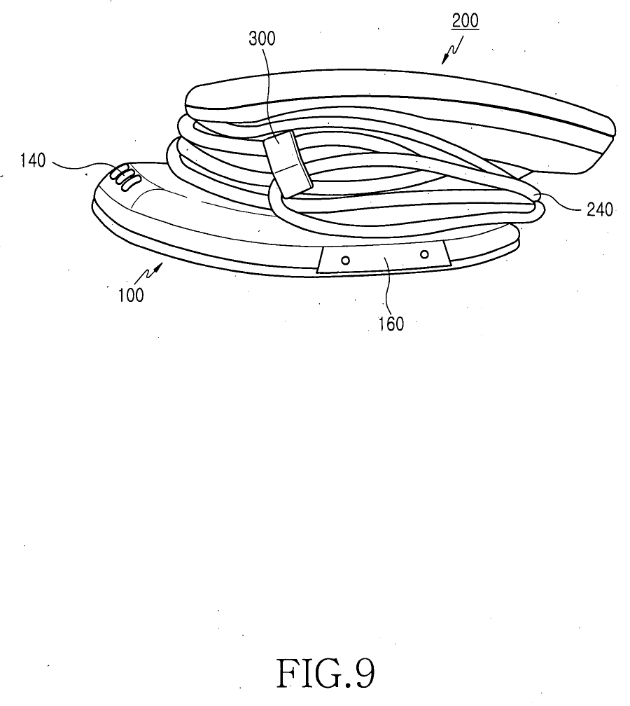

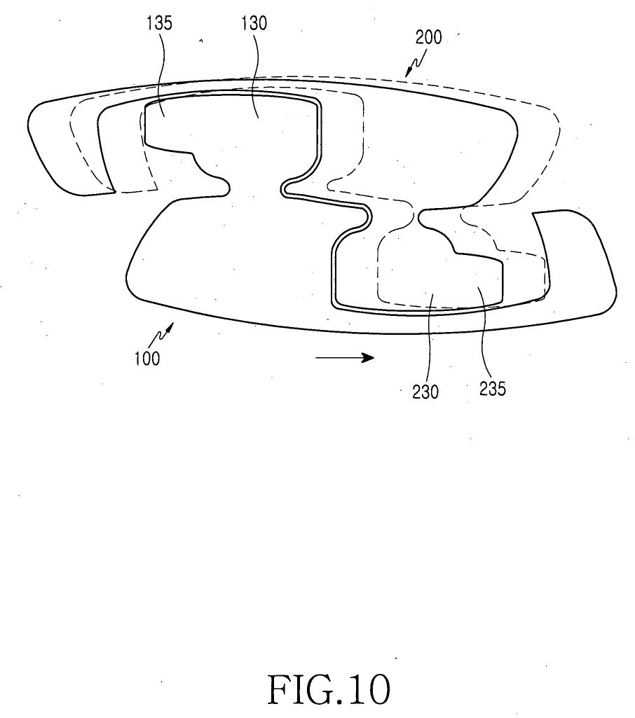

Referring to FIGS. 9 and 10, the first and second earphone parts 100 and 200 are attached to each other in a face to face manner, and the cable 240 is wound around the connection between them and secured by the fixing device 300.

As shown in FIG. 10, the first attachment protrusion 130 can be inserted in the second attachment receptacle 210, and the second attachment protrusion 230 can be inserted in the first attachment receptacle 110. The second earphone part 200 can then be moved parallel relative to the first earphone part 100 so that the outer peripheral surface of the first supporting shell 135 contacts the inside wall of the second attachment receptacle 210, and that of the second supporting shell 235 contacts the inside wall of the first attachment receptacle 110. Accordingly, the first attachment protrusion 130 completely engages the second attachment receptacle 210, and the second attachment protrusion 230 completely engages the first attachment receptacle 110, so as to firmly attach the first and second earphone parts 100 and 200 to each other.

The outer peripheral surfaces of the first and second supporting shells 135 and 235 are adapted to be fitted into the user's ears, so that the first and second earphone parts 100 and 200 are stably held by the ears. Sponge covers may be used instead of the first and second supporting shells 135 and 235 to accommodate the user's ears.

Hereinafter, the cable 240 is described as being wound around the interconnected first and second earphone parts 100 and 200, and secured by the fixing device 300.

The fixing device 300 may be freely moved along the cable 240 inserted in the side-closed hole 310. Before winding the cable 240, the user moves the fixing device 300 to the middle part of the cable 240 or to a position adjacent to one of the first and second earphone parts 100 and 200 in order to facilitate the winding of the cable 240. Then the cable 240 is wound around the interconnected first and second earphone parts 100 and 200 starting from the part of the cable remotest from the fixing device 300 until approaching the part adjacent to the fixing device 300. The winding of the cable 240 is finished with a part of the cable 240 being firmly fixed into the side-opened hole 320, so that the interconnected first and second earphone parts 100 and 200 are prevented from separating even with an unwanted external force.

Referring to FIG. 11, the first selective type headset 10 according to the present invention includes the first earphone part 100 with a first Bluetooth module 190 for performing radio communication with the mobile communication terminal 1, and the second earphone part 200 electrically connected through the cable 240 to the first earphone part 100.

The first earphone part 100 converts a part of an electrical sound signal received by the first Bluetooth module 190 from the mobile communication terminal 1 into a sound wave that is delivered through the first speaker unit 120 to one ear. The intensity of the sound delivered to the user may be adjusted by the volume adjustment 160. The first earphone part 100 is also provided with a microphone for converting a user's voice into electrical sound signals transmitted to the mobile communication terminal 1.

The second earphone part 200 converts the remaining part of the electrical sound signal received from the first earphone part 100 through the cable 240 into another sound wave delivered through the second speaker unit 220 to the other ear.

The first earphone part 100 provided with the first speaker unit 120 and the microphone may be separately used so as to supply mono sounds together with voice communication through the mobile communication terminal 1, or otherwise operated in combination with the second earphone part 200 so as to supply stereo sounds. Thus, the headset 10 may enable the user not only to perform voice communication by separately using the first earphone part 100, but also to enjoy stereo sounds of a sound medium, such as an MP3, by using both of the first and second earphone parts 100 and 200. The second earphone part 200 enables the user to enjoy sounds as if he/she was on the scene. The first and second earphone parts 100 and 200 may be provided with switch buttons for playing/stopping, volume control, music selection, etc., in order to enable the user to enjoy reproducing sound media without direct operation of the mobile communication terminal 1. Switch buttons used for reproducing the sounds of the sound media may be mounted in the second earphone part 200 in view of the roles of the first and second earphone parts 100 and 200.

FIGS. 12 and 13 show the second and third examples of selective type headsets according to the present invention, having a structure similar to the first headset example except for the second Bluetooth module 290 mounted in the second earphone part 200 in addition to the first Bluetooth module 190 mounted in the first earphone part 100. Accordingly the second earphone part 200 is also preferably provided with a built-in storage battery for the second Bluetooth module 290.

Referring to FIG. 12 for illustrating the second selective type headset example, the first earphone part 100 performs radio communication with the mobile communication terminal 1 while the second earphone part 200 performs radio communication with the first earphone part 100 through the second Bluetooth module.

The first earphone part 100 converts a part of an electrical sound signal received from the mobile communication terminal 1 through the first Bluetooth module 190 into a sound wave delivered through the first speaker unit 120 to the user, and transmits the remaining part of the sound signal to the second earphone part 200. The intensity of the sound delivered to the user may be adjusted by the volume adjustment 160. The first earphone part 100 is also provided with a microphone for converting user's voices into electrical sound signals transmitted to the mobile communication terminal 1.

The second earphone part 200 receives the remaining part of the sound signal from the first earphone part 100 through the second Bluetooth module 290, which is converted into another sound wave delivered through the second speaker unit 220 to the user.

The first earphone part 100 provided with the first speaker unit 120 and the microphone may be separately used to supply mono sounds together with voice communication through the mobile communication terminal 1, or otherwise operated in combination with the second earphone part 200 through the second Bluetooth module 290 to supply stereo sounds.

Referring to FIG. 13 for illustrating the third selective type headset example, the first and second earphone parts 100 and 200 independently perform radio communication with the mobile communication terminal 1.

The first and second earphone parts 100 and 200 independently convert the electrical sound signals, separately received from the mobile communication terminal 1 through the respective first and second Bluetooth modules 190 and 290, into their respective sound waves that are delivered to the user. In addition, each of the first and second earphone parts 100 and 200 may be provided with a microphone for converting the user's voice into electrical sound signals transmitted to the mobile communication terminal 1. Thus, if the first and second earphone parts 100 and 200 are provided with their respective communication buttons, the user may perform voice communication by using one of them at all times.

As described above, the selective headset according to the present invention includes the first and second earphone parts 100 and 200 that may be attached to each other in a face to face manner through the first and second attachment protrusions 130 and 230 respectively inserted in the second and first attachment receptacles 210 and 110. In addition, the second earphone 200 serves to supply stereo sound in combination with the first earphone part 100.

Thus, the attachment receptacle and protrusion provided in each of the earphone parts of the selective type headset according to the present invention enables the user to conveniently carry the headset by attaching the earphone parts in a face to face manner. Moreover, the fixing device for securing the cable connecting the earphone parts facilitates handling of the cable. Besides, the two earphones may be combined so as to produce stereo sound.

While the invention has been shown and described with reference to a certain preferred embodiment thereof, it will be understood by those skilled in the art that various changes in form and details may be made therein without departing from the spirit and scope of the invention.

What is claimed is:

1. A selective type headset for a mobile communication terminal, the headset comprising:
a first earphone part having a face provided with a first attachment receptacle and a first attachment protrusion adjacent to said first attachment receptacle; and
a second earphone part having a face provided with a second attachment receptacle and a second attachment protrusion adjacent to said second attachment receptacle, whereby said first earphone part is attachable to said second earphone part in a face to face manner by engaging said first and second attachment protrusions respectively with said second and first attachment receptacles.

2. A selective type headset according to claim 1, further comprising:
a cable extended from one side of said second earphone part; and
a fixing device attached to said cable that has a hole with a side slit, whereby a part of said cable is fixed in said hole to hold said cable wound around a connection between said first and said second earphone part.

3. A selective type headset according to claim 2, wherein said first earphone part has a side provided with a cable connection terminal for electrically connecting said first and second earphone parts through said cable.

4. A selective type headset according to claim 3, wherein said first earphone part converts a part of an electrical sound signal received from said mobile communication terminal into a sound wave, and said second earphone part converts a remaining part of said electrical sound signal into a sound wave.

5. A selective type headset according to claim 4, wherein said first earphone part is adapted to independently produce a mono sound.

6. A selective type headset according to claim 1, wherein said first and second attachment protrusions have speaker units respectively installed in them.

7. A selective type headset according to claim 1, wherein said first earphone part is provided with a built-in storage battery and a charging terminal adjacent to said first attachment receptacle for recharging said storage battery through connection with an external power supply.

8. A selective type headset according to claim 1, wherein said first earphone part is provided with a first Bluetooth module for performing radio communication with said mobile communication terminal.

9. A selective type headset according to claim 8, wherein said second earphone part is provided with a second Bluetooth module for performing radio communication with said first earphone part.

10. A selective type headset according to claim 9, wherein said first earphone part is adapted to independently produce a mono sound.

11. A selective type headset according to claim 8, wherein said second earphone part is provided with a second Bluetooth module for performing radio communication with said mobile communication terminal.

12. A selective type headset according to claim 1, wherein said first earphone part is provided with a microphone for converting a user's voice into an electrical signal, and a Bluetooth module for transmitting said electrical signal to said mobile communication terminal, thereby performing voice communication function.

13. A selective type headset according to claim 1, wherein said first and second attachment protrusions have respective peripheries surrounded by supporting shells whose peripheral surfaces respectively abut inside walls of said first and second attachment receptacles.

14. A selective type headset according to claim 13, wherein the peripheral surfaces of said supporting shells are adapted to fit into a user's ears, thereby enabling said first and second attachment protrusions to be stably held in the ears.

15. A selective type headset according to claim 1, wherein one of said first and second earphone parts is provided with at least one button.

16. A selective type headset according to claim 15, wherein at least one of said first and second earphone parts is provided with a Bluetooth module for performing radio communication with said mobile communication terminal.

17. A selective type headset according to claim 4, wherein said first and second earphone parts are adapted to produce a stereo sound in combination.

18. A selective type headset according to claim 9, wherein said first and second earphone parts are adapted to produce a stereo sound in combination.
